(19) United States
(12) Patent Application Publication
(10) Pub. No.: US 2015/0173097 A1
(43) Pub. Date: Jun. 18, 2015

(54) Method And Apparatus For Coordinated Uplink Scheduling

(71) Applicant: Alcatel-Lucent USA Inc., Murray Hill, CA (US)

(72) Inventors: Krishna Balachandran, Morganville, NJ (US); Joseph H. Kang, Belle Mead, NJ (US); Kemal M. Karakayali, Hoboken, NJ (US); Kiran M. Rege, Marlboro, NJ (US)

(73) Assignee: Alcatel-Lucent USA Inc., Murray Hill, NJ (US)

(21) Appl. No.: 14/133,025

(22) Filed: Dec. 18, 2013

(51) Int. Cl. H04W 72/12; H04W 36/18

(52) U.S. Cl. CPC H04W 72/1215; H04W 36/18; H04W 92/20

(57) ABSTRACT

Various methods and devices are provided to address the need for interference mitigation in heterogeneous wireless networks. In one method, a small cell network node provides (301) diversity reception for uplink communications of user equipment (UE) served by a macro cell network node. The small cell network node and the macro cell network node coordinate (302) the scheduling of uplink resource blocks so that the UE and user equipment served by the small cell network node are not scheduled during the same uplink resource blocks.

### REFERENCE(S) TO RELATED APPLICATION(S)

This application is related to a co-pending application Ser. No. 13/357,965, entitled “NETWORK NODE AND METHOD FOR VIRTUAL SOFT HANDOFF OPERATION,” filed Jan. 25, 2012, which is commonly owned and incorporated herein by reference in its entirety.

### FIELD OF THE INVENTION

The present invention relates generally to communications and, in particular, to wireless communication systems incorporating both macro cells and small cells.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

In heterogeneous wireless networks, small cells with low transmission power operate in the same carriers as high power macro cells. As a result of the power difference, the small cell coverage areas are limited, there is little offloading of users to small cells, and the vast majority of users are served by the macro. Various techniques (e.g., ABS, bias) can be used to achieve cell range expansion, but studies have shown that to achieve desirable performance (e.g., avoidance of handoff failures, dropped calls), these values can be quite limited. As a result, the macro cell must serve a large number of users and each user has access to only a small amount of resource. Hence, users on the edge of macro coverage suffer from poor downlink and uplink rates due to poor channel quality and limited access to bandwidth.

Further, the power difference between macro and small cells cause an asymmetry between the uplink and downlink, where the base station with highest received power may be different on the downlink (DL) and uplink (UL). For instance, a user may be located very close to the small cell, but served by the macro cell due to the macro's huge power advantage. Such users will transmit at high powers to overcome the large path loss to the serving macro and thus cause significant interference to the nearby small cell.

To address this problem, most solutions employ almost blanked subframes (ABS) and enhanced inter-cell interference coordination (e-ICIC). By almost blanking some subframes, macro interference to small cells is reduced and a larger bias can be employed wherein users in the cell range expansion area can be served when the macro is “almost blanked.”

There are two issues with this solution. First, as mentioned above, internal studies have indicated that the bias is typically limited to 7-8 dB in order to achieve desirable performance. This difference is not enough to overcome the large (up to a 16 dB or even larger) power advantage for macros. Second, the ABS-based solution is focused on addressing the huge macro power advantage on the downlink. On the uplink, there is no power advantage (the user equipment (UE) is the one transmitting) and blanking macro subframes ultimately takes away resources from the macro users who already have limited access to resources (due to limited offload).

Thus, new solutions and techniques that are able to address one or more of these interference issues would meet a need and advance wireless communications generally.

### BRIEF DESCRIPTION OF THE DRAWINGS

FIG. 1 is a depiction of a wireless network with a small cell and a macro cell.

FIG. 2 is a depiction of an example scenario of Virtual Soft-handoff Blanking (VSHO-Blanking) in accordance with various embodiments of the present invention.

FIG. 3 is a logic flow diagram of functionality performed by a small cell network node and a macro cell network node in accordance with various embodiments of the present invention.

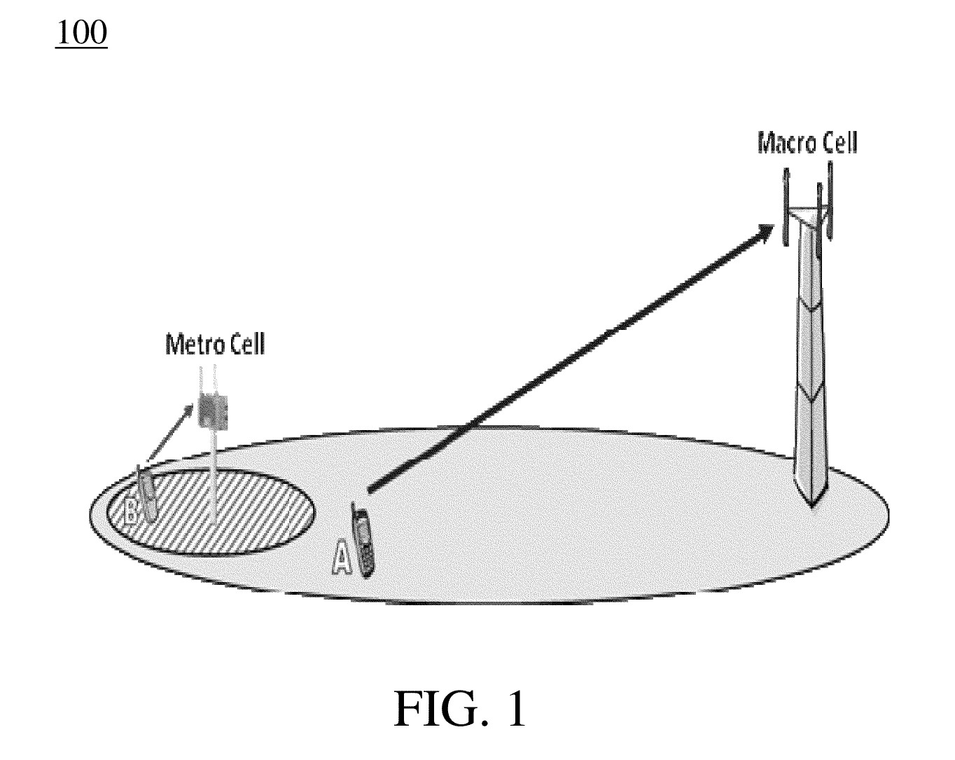

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address the need for interference mitigation in heterogeneous wireless networks. In one method, a small cell network node provides diversity reception for uplink communications of user equipment (UE) served by a macro cell network node. The small cell network node and the macro cell network node coordinate the scheduling of uplink resource blocks so that the UE and user equipment served by the small cell network node are not scheduled during the same uplink resource blocks. An article of manufacture is also provided, the article comprising a non-transitory, processor-readable storage medium storing one or more software programs which when executed by one or more processors performs the steps of this method.

Many embodiments are provided in which the method above is modified. For example, depending on the embodiment, providing diversity reception for uplink communications of the UE may involve supporting a soft handoff or a virtual soft handoff (VSHO) of the UE. Also, depending on the embodiment, coordinating the scheduling of uplink resource blocks may involve establishing a scheduling pattern by which the UE and user equipment served by the small cell network node are not scheduled during the same uplink resource blocks. Coordinating the scheduling of uplink resource blocks may, additionally or alternatively, involve communicating by the macro cell network node to the small cell network node information indicating the uplink resource blocks to which the UE has been scheduled and then scheduling the user equipment served by the small cell network node using this information to avoid overlapped scheduling.

An apparatus that includes a macro cell network node and a small cell network node is also provided. The macro cell network node is operative to serve a UE, and the small cell network node is configured to communicate with the macro cell network node and is operative to provide diversity reception for uplink communications of the UE and to serve a group of small cell user equipment. The small cell network node and the macro cell network node are operative to coordinate the scheduling of uplink resource blocks so that the UE and the group of small cell user equipment are not scheduled during the same uplink resource blocks. Many embodiments are provided in which this apparatus is modified. Examples of such embodiments can be found described above with respect to the method.

Various networking equipment architectures may be used to implement this apparatus. In many embodiments, a 3GPP Long Term Evolution (LTE)-based architecture is used. For example, the macro cell network node and the small cell network node may communicate via an X2 interface, and in some embodiments the macro cell network node may comprise an Enhanced NodeB (eNodeB).

### DETAILED DESCRIPTION OF EMBODIMENTS

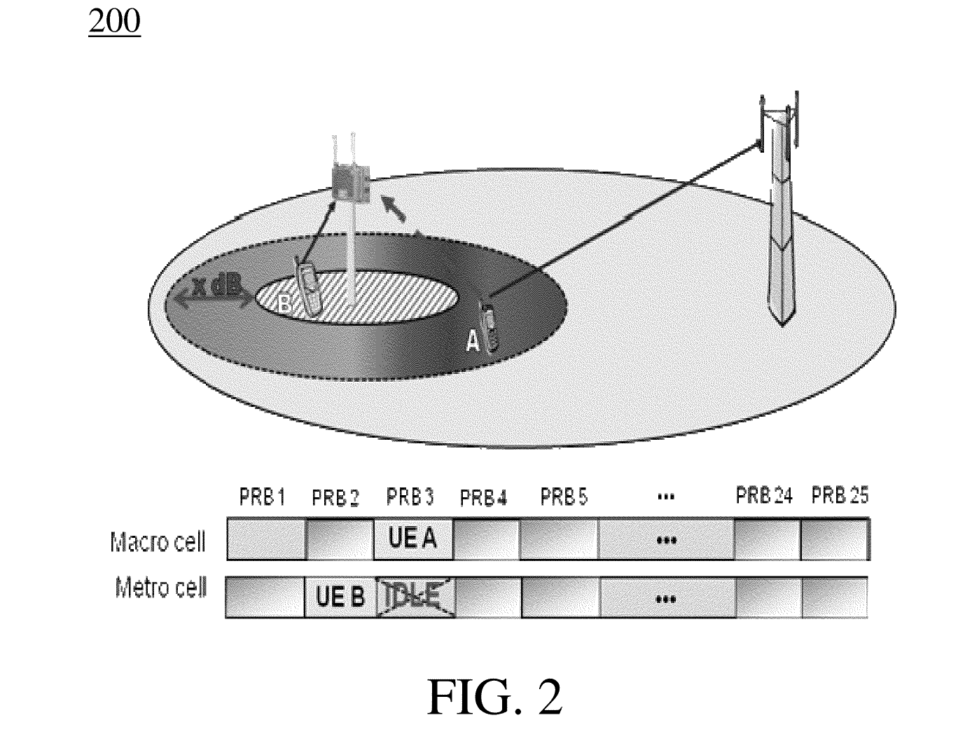

To provide a greater degree of detail in making and using various aspects of the present invention, a description of our approach to interference mitigation and a description of certain, quite specific, embodiments follows for the sake of example. FIGS. 1 and 2 are referenced in an attempt to illustrate some examples of specific interference problems in heterogeneous networks (HetNets) and specific embodiments of the present invention.

A typical HetNet setup is shown in FIG. 1 where an outdoor small cell (metro-cell) is placed within the coverage area of a macro-cell on the same frequency band (co-channel deployment). Each UE/mobile is served either by a macro-cell or a small cell based on the downlink received signal strength measurements. Typically, a macro-cell transmit power is much larger than a small-cell transmit power (e.g. 10-15 dB higher). As a result, a large fraction of UE/mobile users receives a stronger downlink signal from the macro and therefore is served by the macro-cell. This has a number of important implications: First, since a metro-cell typically serves a smaller number of users, metro users can have access to relatively large bandwidth allocations giving the metro users higher data rates compared to a typical macro-user. Secondly, macro users may have to transmit at relatively higher power levels compared to typical metro users since they are farther away from their serving node.

For instance, as depicted in network 100 of FIG. 1, mobile A is just outside the coverage area of a metro-cell (i.e., it has a stronger downlink signal from the macro-cell) and is served by the macro-cell despite being closer to the metro-cell. In the uplink, mobile A needs to compensate for higher path-loss with respect to its serving node and therefore transmits at a relatively higher power level in comparison to mobile B. This causes strong interference at the metro-cell, which in turn pushes the metro-user to increase its own transmit power leading to higher interference levels in the network.

One potential solution to the above issues is Virtual Soft-handoff (VSHO) which facilitates decoding of users at their best uplink reception points, instead of at their serving node associations determined by the downlink control channel measurements. This is done by creating “virtual” soft-handoff modes for macro users near metro-cells (e.g. for mobile A in network 100). Note that the current 3GPP Long-Term Evolution (LTE) specifications do not support soft-handoff and therefore LTE-compatible mobile devices do not have the capability to initiate a soft-handoff request to other cells. Furthermore, implementing traditional soft-handoff in a HetNets environment is a challenge. For instance, due to large transmit power differences between macro and metro cells, some macro users near metro-cells (potential VSHO candidates) measuring the signal strength from nearby transmitters would receive a significantly stronger signal from the macro-cell and, therefore, would not initiate a soft-handoff request to a metro-cell with a much weaker received signal. With VSHO, soft-handoff operation is transparent to the mobile and is enabled by cooperation among the macro and metro-cells.

Despite its potential benefits, VSHO does not fully solve the interference problem in HetNets. One remaining issue to be solved is the interference and resource contention between macro and metro users. In network 100, mobiles A and B transmit simultaneously and therefore interfere with each other. While decoding mobile A at a nearby metro-cell can help to improve its reception quality, strong interference from mobile B's transmission may still limit the potential VSHO benefits.

The concept of resource blanking at metro-cells is one possible solution and is based on the observation that since metro-cells typically serve a smaller number of mobiles, per-user resource allocations for metro users are, in general, larger than those for typical macro users. Consequently, even with blanking, metro users can still be served with relatively high throughputs while the macro-user in VSHO mode can greatly benefit from interference avoidance at the metro-cell. Notice that this type of uplink resource blanking is, in a way, a dual to the manner in which the Almost Blanked Sub-frame (ABS) technique standardized by 3GPP LTE works on the downlink. With ABS, macro blanking helps to improve metro users' reception on the downlink; in our proposal, metro blanking helps to improve macro users' reception on the uplink.

A sample VSHO-Blanking scenario is depicted by network 200 in FIG. 2, where UEs A and B are scheduled on different physical resource blocks and no metro user is scheduled on the same physical resource block (PRB) with UE A, providing the macro user interference avoidance benefits. That is, UE A (with the macro cell as its primary serving cell) is in VSHO with the metro cell and is getting its uplink transmissions decoded at the metro cell. In order to facilitate this decoding, the metro cell does not schedule any of the UEs it is serving (such as UE B) during the PRBs that are being used by UE A. As a result, with this VSHO-Blanking technique, UE A can benefit from diversity reception across the macro and metro cell as well as interference avoidance at the metro cell.

VSHO-Blanking can be implemented by way of scheduling coordination between the macro and metro cells. For instance, the macro and metro can agree on a blanking pattern for the metro so that the macro can schedule its VSHO UEs only during the resource blocks that are blanked by the metro. Alternatively, in a “master-slave” arrangement, the macro might do its scheduling first and then inform the metro of the UEs it has scheduled. Then, when the metro prepares its own schedule, it makes sure that its own UEs are not scheduled for uplink transmissions over the set of PRBs that a VSHO UE has already been scheduled over.

As alluded to above, blanking patterns may be established through scheduling coordination between the macro and metro cells either semi-statically or dynamically. With semi-static blanking, a fixed and recurring block of the uplink resources of the metro-cell may be idled for VSHO operation. The size of this block may be determined based on the deployment scenario or traffic load. With dynamic blanking, resources at the metro-cell can be idled on a faster time-scale, possibly even on frame-by-frame basis.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

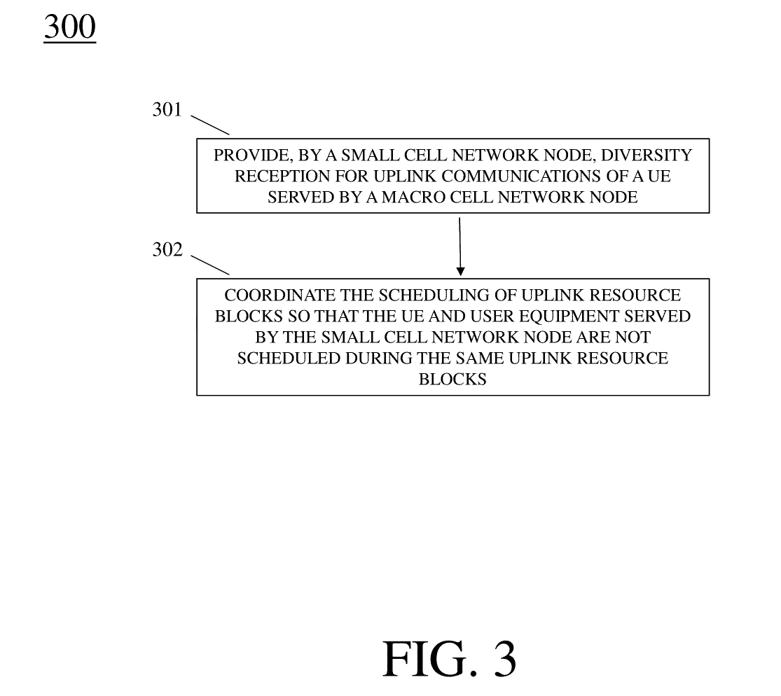

Aspects of embodiments of the present invention can be understood with reference to FIG. 3. Diagram 300 of FIG. 3 is a logic flow diagram of functionality performed by a small cell network node and a macro cell network node in accordance with various embodiments of the present invention. In most embodiments, the small cell network node and the macro cell network node comprise wireless devices, such as base stations, with antennas for wireless communication with other wireless devices, such as user equipment. They also typically have network interfaces, typically wired (although possibly wireless or both), for communication with other communication network equipment.

In the method depicted in diagram 300, the small cell network node provides (301) diversity reception for uplink communications of user equipment (UE) served by the macro cell network node. Depending on the embodiment, providing diversity reception may involve the small cell network node supporting the UE in soft handoff or supporting the UE in a virtual soft handoff (VSHO). To further the diversity reception of the UE, the small cell network node and the macro cell network node coordinate (302) the scheduling of uplink resource blocks so that the UE and user equipment served by the small cell network node are not scheduled during the same uplink resource blocks.

Depending on the embodiment, coordinating the scheduling of uplink resource blocks may involve establishing a scheduling pattern by which the UE and user equipment served by the small cell network node are not scheduled during the same uplink resource blocks. Coordinating the scheduling of uplink resource blocks may, additionally or alternatively, involve communicating by the macro cell network node to the small cell network node information indicating the uplink resource blocks to which the UE has been scheduled and then scheduling the user equipment served by the small cell network node using this information to avoid overlapped scheduling of the same uplink resource block.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method comprising:
providing, by a small cell network node, diversity reception for uplink communications of user equipment (UE) served by a macro cell network node;
coordinating, by the small cell network node and the macro cell network node, the scheduling of uplink resource blocks so that the UE and user equipment served by the small cell network node are not scheduled during the same uplink resource blocks.

2. The method as recited in claim 1, wherein providing diversity reception for uplink communications of the UE comprises
supporting a soft handoff of the UE.

3. The method as recited in claim 1, wherein providing diversity reception for uplink communications of the UE comprises
supporting a virtual soft handoff (VSHO) of the UE.

4. The method as recited in claim 1, wherein coordinating the scheduling of uplink resource blocks comprises
establishing a scheduling pattern by which the UE and user equipment served by the small cell network node are not scheduled during the same uplink resource blocks.

5. The method as recited in claim 1, wherein coordinating the scheduling of uplink resource blocks comprises
communicating, by the macro cell network node to the small cell network node, information indicating the uplink resource blocks to which the UE has been scheduled;
scheduling the user equipment served by the small cell network node using the information from the macro cell network node to avoid overlapped scheduling.

6. An article of manufacture comprising a processor-readable storage medium storing one or more software programs which when executed by one or more processors performs the steps of the method of claim 1.

7. An apparatus comprising:
a macro cell network node operative to serve a user equipment (UE); and
a small cell network node being configured to communicate with the macro cell network node,
wherein the small cell network node is operative to provide diversity reception for uplink communications of the UE and to serve a group of small cell user equipment,
wherein the small cell network node and the macro cell network node are operative to coordinate the scheduling of uplink resource blocks so that the UE and the group of small cell user equipment are not scheduled during the same uplink resource blocks.

8. The apparatus as recited in claim 7, wherein being operative to provide diversity reception for uplink communications of the UE comprises
being operative to support a soft handoff of the UE.

9. The apparatus as recited in claim 7, wherein being operative to provide diversity reception for uplink communications of the UE comprises
being operative to support a virtual soft handoff (VSHO) of the UE.

10. The apparatus as recited in claim 7, wherein being operative to coordinate the scheduling of uplink resource blocks comprises
being operative to establish a scheduling pattern by which the UE and the group of small cell user equipment are not scheduled during the same uplink resource blocks.

11. The apparatus as recited in claim 7, wherein being operative to coordinate the scheduling of uplink resource blocks comprises
the macro cell network node being operative to communicate information indicating the uplink resource blocks to which the UE has been scheduled and
the small cell network node being operative to schedule the group of small cell user equipment using the information from the macro cell network node to avoid overlapped scheduling.

12. The apparatus as recited in claim 7, wherein the macro cell network node and the small cell network node are operative to communicate via an X2 interface.

13. The apparatus as recited in claim 7, wherein the macro cell network node comprises an Enhanced NodeB (eNodeB).
